(19) United States
(12) Patent Application Publication
(10) Pub. No.: US 2008/0001012 A1
(43) Pub. Date: Jan. 3, 2008

(54) Bulk Material Breaker

(75) Inventors: Klaus Wenzeis, Wurmannsquick (DE); Johann Schuster, Emmerting (DE); Jan Stodulka, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/768,379

(22) Filed: Jun. 26, 2007

(30) Foreign Application Priority Data
Jun. 29, 2006 (DE) 10 2006 030 004.1

(51) Int. Cl. B02C 13/28

(52) U.S. Cl. 241/278.2

(57) ABSTRACT

A bulk material breaker has a housing in the form of a drum having at least one shearing finger on the internal wall thereof, an upwardly directed rotationally driven cone having at least one shearing profile thereon, a gap between the cone and the housing wall, and a collecting hopper beneath the cone.

### BACKGROUND OF THE INVENTION

1. Field of the Invention

The invention relates to a big bag emptying and breaking station.

2. Background Art

Receiving vessels for granulates and conveyor installations such as suction conveyors, e.g. systems of the company Mann & Hummel, or mechanical systems, e.g. conveyor spirals or conveyor worms, e.g. of the company Brabender, and compressed-air conveyor systems, e.g. rotary feeders, are known.

Material is prepared in granulate form and packed in special large packagings (big bags). During storage, conditioned by their own weight and by vibrations during transport, by trucks, for example, the pellets become compacted and agglomerate in the big bag into large lumps.

With known installations, conveyance of the material is then no longer possible. When agglomerated silicone granulates, for example, are broken up with standard commercially available devices, the material plasticizes completely irreversibly and can then no longer be conveyed.

### SUMMARY OF THE INVENTION

An object of the invention is to solve the problems of the prior art, and in particular to provide a device with which caked-together bulk material is reseparated. This object is achieved by virtue of the invention. A downstream new technology ensures that the pellets, after having been emptied into an appropriate receiving vessel, are broken up again and can then be conveyed fully automatically. These and other objects are met by the invention.

### BRIEF DESCRIPTION OF THE DRAWINGS

FIG. 1 illustrates one embodiment of the bulk material breaker of the present invention.

### DETAILED DESCRIPTION OF THE PREFERRED EMBODIMENT(S)

The subject of the invention is a bulk material breaker, characterized in that it has a housing in the form of a drum having at least one shearing finger on the internal wall, an upwardly directed cone having at least one shearing profile thereon, a gap between the cone and the housing wall, and a collecting hopper beneath the cone.

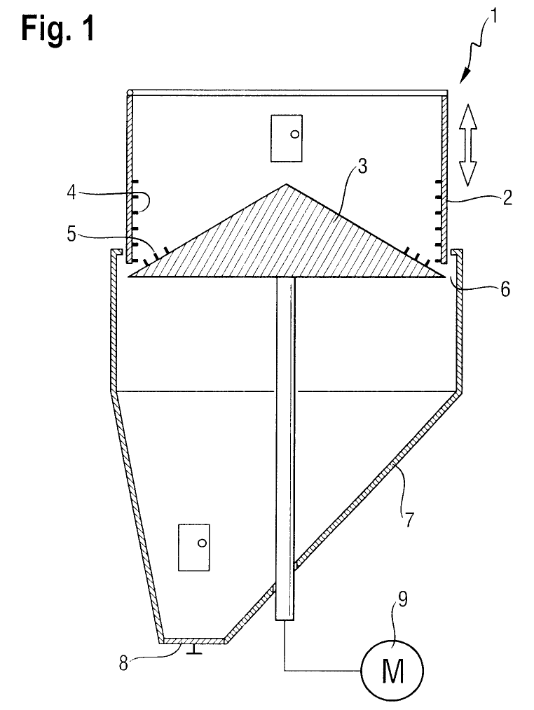

In FIG. 1, a bulk material breaker according to the invention is shown, this breaker having a drum (1) to which shearing fingers (4) are attached to the walls thereof. Located in this drum (1) is the cone (3), which has shearing profiles (5). The cone (3) has, between the collecting hopper (7) and the cone (3), a feed gap (6) through which the pellets fall into the collecting hopper (7) and fall out through the outlet opening (8), the cone (3) preferably being driven by a motor.

The housing, which is charged with the bulk material, preferably has the shape of a drum, on which, at preferably regular or even irregular intervals, preferably at regular intervals, shearing fingers are attached to the drum wall, preferably at an angle from 60° to 140°, more preferably 80° to 110°, and most preferably 85° to 95° to the drum wall, these shearing fingers preferably being located one above the other or optionally in a mutually offset arrangement, but preferably one above the other, distributed over the drum wall. Most preferably, they are fitted opposite one another at two, four, six or eight places on the drum wall, four places being preferred and two places being particularly preferred. The shearing fingers preferably have a length of 6% of the diameter of the drum or less, preferably 3% or less, and most preferably 1.5% of the drum diameter. Combinations of lengths are especially preferred. Preferably, the drum has the shearing fingers on the internal wall at a height up to the filling material height.

Inside the drum there is a rotatable cone, which is disposed in a collecting hopper. The cone is defined by two mutually intersecting generating lines of the cone, preferably with an apex angle of 30° to 60°.

On the cone there are preferably at regular or irregular intervals, more preferably at regular intervals, shearing profiles fitted on the cone, these being preferably located one above the other or in mutually offset arrangement, preferably one above the other, distributed over the cone. Preferably, 1, 2, 3, 4, 5, 6, 7, 8, 9, or 10 shearing profiles are one above the other or distributed over the cone. Particular preference is for two shearing profiles one above the other. The shearing profiles preferably have a length of 6% or less of the diameter of the cone, preferably 3%, or less, and most preferably about 1.5%, most preferably applied in combinations. The shearing profiles preferably have an angle from 60° to 120° to the generating surface of the cone.

The bulk material breaker possesses a gap between the collecting hopper and the cone, which, in a particularly preferred embodiment, is adjustable, so that it can be adjusted to the size of the respective bulk material.

In addition, the bulk material breaker according to the invention has a drive mechanism for the cone to rotate it at a specific rotational velocity. The rotation velocity of the cone is preferably continuously adjustable dependent on material properties, gap height and required material volume. Preferably, the bulk material breaker according to the invention receives material in quantities up to 1000 kg or more.

The breaking up of the agglomerated components in the bulk material breaker is realized as follows: during the rotation of the material in the filling chamber drum (1), the bridgings of the granulate are broken up by the shearing effect of the shearing fingers (4) attached to the drum wall (2) and the shearing profiles (5) attached to the cone (3). The broken-up pellets fall through a variably adjustable feed gap (6) into the conveyor system. The precise tuning of the rotational velocity and of the feed gap width (6) to the respective material is important to prevent further clogging of the material in the lump breaker. Low rotational velocities should generally be chosen.

The broken-up material is transported onward in the conveyor system (forced conveyance mechanically, or by vacuum or by compressed air) to the finishing unit (extruder, injection molding machine or similar). Through a fill level monitoring (min-max level control or similar principle) on the conveyor system, any further agglomeration of the pellets falling from the breaker is prevented, the speed of the lump breaker and of the conveyor system being coupled to the control circuit of the target production unit. Lengthy conveying distances can in this case be covered. Similarly, the material can be distributed to various processing machines.

Preferably, the bulk material breaker according to the invention can be used to break up silicone granulate, but the breaking up of any other plastic granulate types is also possible.

Through the additional use of the newly developed breaking mechanism, a fully automatic charging of linked processing systems (e.g. injection molding or extrusion) is possible.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A bulk material breaker, comprising a housing in the form of a drum having at least one shearing finger on an internal wall thereof, an upwardly directed rotatable cone having at least one shearing profile thereon, a gap between the cone and the housing wall, and a collecting hopper beneath the cone.

2. The bulk material breaker of claim 1, wherein the drum has shearing fingers on the internal wall at least up to a filling material height.

3. The bulk material breaker of claim 1, wherein the cone has at least two shearing profiles.

4. The bulk material breaker of claim 2, wherein the cone has at least two shearing profiles.

5. The bulk material breaker of claim 1, wherein the gap between the cone and the housing wall is adjustable.

6. The bulk material breaker of claim 2, wherein the gap between the cone and the housing wall is adjustable.

7. The bulk material breaker of claim 3, wherein the gap between the cone and the housing wall is adjustable.

8. The bulk material breaker of claim 4, wherein the gap between the cone and the housing wall is adjustable.

9. The bulk material breaker of claim 1, wherein the drum is sized such that it can receive material quantities of up to 1000 kg.

10. The bulk material breaker of claim 2, wherein the drum is sized such that it can receive material quantities of up to 1000 kg.

11. The bulk material breaker of claim 3, wherein the drum is sized such that it can receive material quantities of up to 1000 kg.

12. The bulk material breaker of claim 4, wherein the drum is sized such that it can receive material quantities of up to 1000 kg.

13. The bulk material breaker of claim 5, wherein the drum is sized such that it can receive material quantities of up to 1000 kg.

14. The bulk material breaker of claim 1 wherein the shearing fingers have a length which is about 6% of the diameter of the drum or less, and the shearing fingers are directed at an angle of from 60° to 140° to the drum wall.

15. The bulk material breaker of claim 1, wherein an apex angle of the cone is from 30° to 60°, the shearing fingers have a length which is about 6% of the cone diameter at its largest point, and are disposed at an angle of 60° to 120° from a generating surface of the cone.
